(19) United States
(12) Patent Application Publication
(10) Pub. No.: US 2012/0255418 A1
(43) Pub. Date: Oct. 11, 2012

(54) Combined metal and composite violin construction

(75) Inventor: Samuel Allen Hart, Duvall, WA (US)

(73) Assignee: Samuel Allen Hart, Duvall, WA (US)

(21) Appl. No.: 13/066,161

(22) Filed: Apr. 8, 2011

(51) Int. Cl. G10D 1/02

(52) U.S. Cl. 84/275

(57) ABSTRACT

A new method for construction of a violin or instrument of the violin family comprising a combination of light weight metal and composite materials. Components are joined using fasteners whenever possible to simplify assembly and disassembly. The results of this method are enhanced environmental stability, durability, and serviceability over existing violin designs.

### CROSS-REFERENCE TO RELATED APPLICATIONS

Not Applicable

### FEDERALLY SPONSORED RESEARCH

Not Applicable

### BACKGROUND

1. Field

This invention relates to the manufacture and crafting of a musical instrument of the violin family. Specifically the desire to create said instrument having the properties of environmental stability, durability, and serviceability while still producing a beautiful musical quality.

2. Prior Art

Presently, the existing standard construction for violins and violin family instruments is a multitude of wood pieces. These wood pieces being hand fitted and semi-permanently bonded together using glues.

This existing standard creates an instrument that is very sensitive to environmental variables, i.e. humidity, temperature, pressure, etc. Wood instruments can suffer damage from exposure to even minor changes in these variables. This damage can be as minor as tonal changes and scratches or as significant as bonding failure, cracking, or the sound post puncturing the sound board. All of these types of damage difficult to repair due to the semi-permanent bonding.

In addition, due to the soft nature of the materials used, wood instruments suffer wear and tear during their normal use. This includes periodic nut, bridge, peg, and fingerboard replacement. Due to the variability of hand fitted components, this wear and tear must be repaired by a professional luthier or someone of significant skill in the art.

There have been many attempts to eliminate some of these issues through the use of carbon fiber or other composites in the construction of violins and other instruments. Patented examples include U.S. Pat. No. 3,699,836 to Glasser (1972), U.S. Pat. No. 4,364,990 to Haines (1982), U.S. Pat. No. 4,408,516 to John (1983), U.S. Pat. No. 4,955,274 to Stephens (1990), U.S. Pat. No. 5,171,926 to Besainou et al. (1992), U.S. Pat. No. 5,333,527 to Janes et al. (1994), U.S. Pat. No. 6,107,552 to Coomar et al. (2000), U.S. Pat. No. 6,284,957 to Leguia (2001), U.S. Pat. No. 6,610,915 to Schleske (2003), U.S. Pat. No. 6,737,568 to Schleske (2004), U.S. Pat. No. 6,770,804 to Schleske (2004), U.S. Pat. No. 7,208,665 to Schleske (2007). These designs are more resistant to environmental variables than a wood violin and have produced violins of acceptable sound quality. However these patents are focused on soundboard construction and still rely on the conventional techniques of wood nuts, wood bridges and wood fingerboards that require professional maintenance. In addition the composite components in these designs are permanently bonded and in the case of damage cannot be repaired easily.

There have also been attempts to eliminate some of these issues by using aluminum or other light metals. A patented example is U.S. Pat. No. 1,941,595 to Burdick (1934). While these may be more environmentally stable and more repairable they still rely on conventional techniques of wood nuts, wood bridges and wood fingerboards that require professional maintenance. Although beautiful the all aluminum violin did not become popular due to not producing an acceptable quality of sound.

### DRAWINGS—FIGURES

FIG. 1 is the front view of a violin conforming to one embodiment of the invention.

FIG. 2 is the back view of the violin from FIG. 1.

FIG. 3 is a detail of the neck sub-assembly of the violin from FIG. 1.

FIG. 4 is a detail of the body assembly of the violin from FIG. 1 showing its attachment to the neck sub-assembly from FIG. 3.

FIG. 5 is a detail of the top assembly of the violin from FIG. 1 showing its attachment to the neck and body assembly from FIG. 4.

FIG. 6 is a perspective view of the Side of the violin from FIG. 1.

FIG. 7 is a perspective view of the Bridge of the violin from FIG. 1.

FIG. 8 is a perspective view of the Button of the violin from FIG. 1 sometimes called the Endpin.

FIG. 9 is a perspective view of the Top and Bass Bar of the violin from FIG. 1 showing the placement of the Bass Bar when it is attached to the Top.

FIG. 10 is a perspective view of the Top Edge Trim of the violin from FIG. 1.

FIG. 11 is a perspective view of the Fingerboard of the violin from FIG. 1 showing hidden lines as dashed lines.

FIG. 12 is a perspective view of the Left Pegboard of the violin from FIG. 1 showing hidden lines as dashed lines.

FIG. 13 is a perspective view of the Pegboard Spacer of the violin from FIG. 1 showing hidden lines as dashed lines.

FIG. 14 is a perspective view of the Right Pegboard of the violin from FIG. 1 showing hidden lines as dashed lines.

FIG. 15 is a perspective view of the Back and Soundpost Guide of the violin from FIG. 1 showing the placement of the Soundpost Guide when it is attached to the Back.

FIG. 16 is a perspective view of the Back Edge Trim of the violin from FIG. 1.

FIG. 17 is a perspective view of the Neck of the violin from FIG. 1 showing hidden lines as dashed lines.

FIG. 18 is a perspective view of the Bass Bar of the violin from FIG. 1.

FIG. 19 is a perspective view of the Soundpost of the violin from FIG. 1.

FIG. 20 is a perspective view of the Soundpost Guide of the violin from FIG. 1.

### REFERENCE NUMERALS

2 Side

4 Bridge

6 Tailpiece

8 Button

10 Top

12 Screw

14 Top Edge Trim

16 String

18 Fingerboard

20 Left Pegboard

22 Pegboard Spacer

24 Right Pegboard

26 Peg

28 Screw

30 Back

32 Back Edge Trim

34 Neck

36 Screw

38 Setscrew

40 Soundpost Guide

42 Screw

44 Soundpost

46 Screw

48 Bass Bar

### DETAILED DESCRIPTION

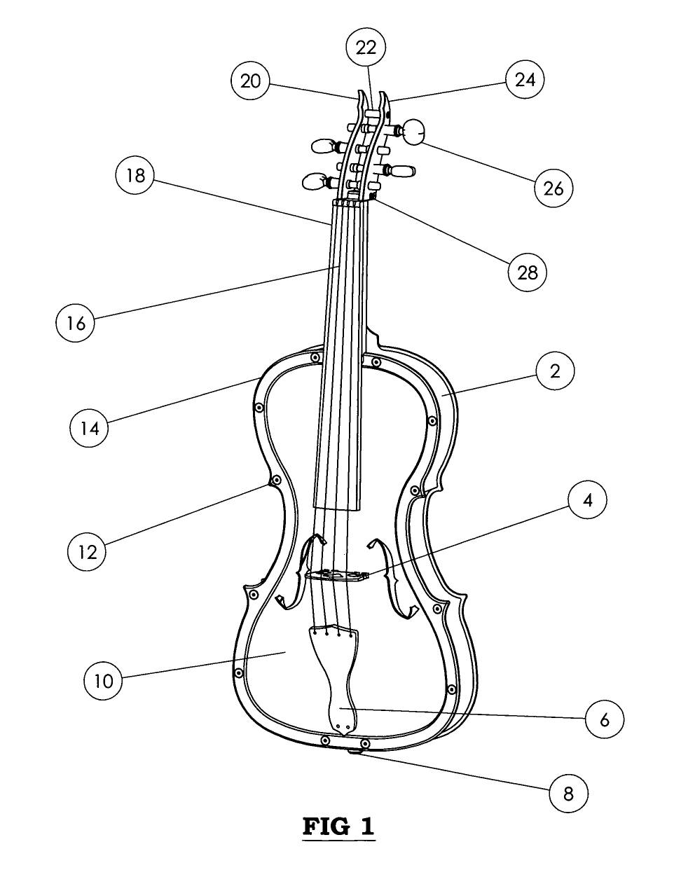

The front view of one embodiment of the violin is illustrated in FIG. 1. FIG. 2 shows the back view. The following description will describe the manufacture and assembly of this embodiment. Each piece of this embodiment is either molded from a carbon fiber/epoxy composite or machined from aluminum. For the rest of the description carbon fiber/epoxy composite will be referred to as CF and aluminum as AL.

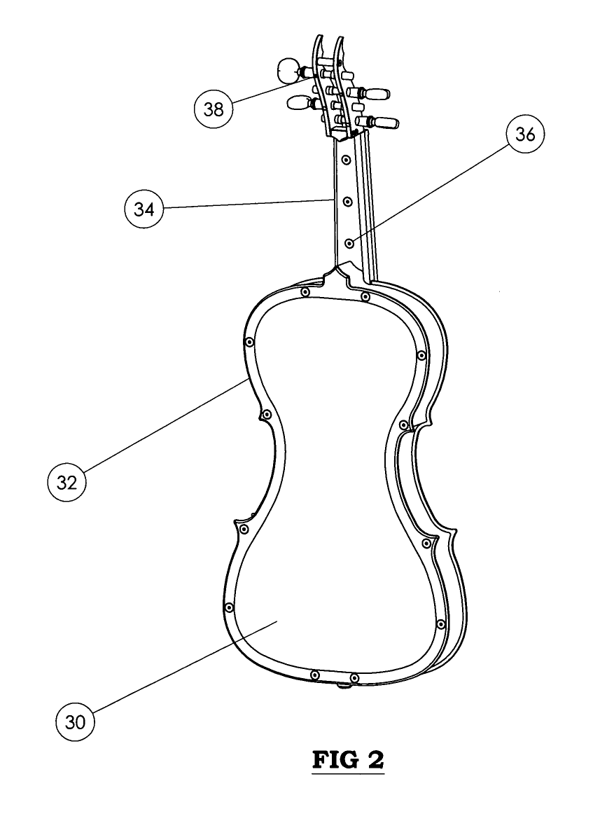

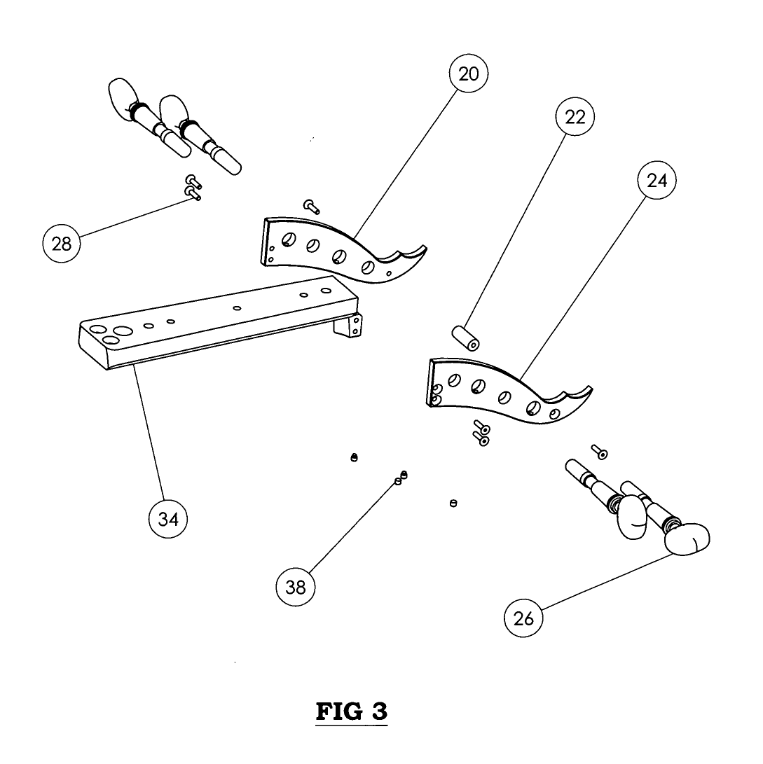

The neck sub-assembly in FIG. 3 begins with an AL Neck 34 to which an AL Left and Right Pegboards, 20 and 24, are affixed by Screws 28. An AL Pegboard Spacer 22 is affixed between the Pegboards. Four planetary type Pegs 26, such as Perfection Pegs manufactured by Knilling, are installed and secured with Setscrews 38.

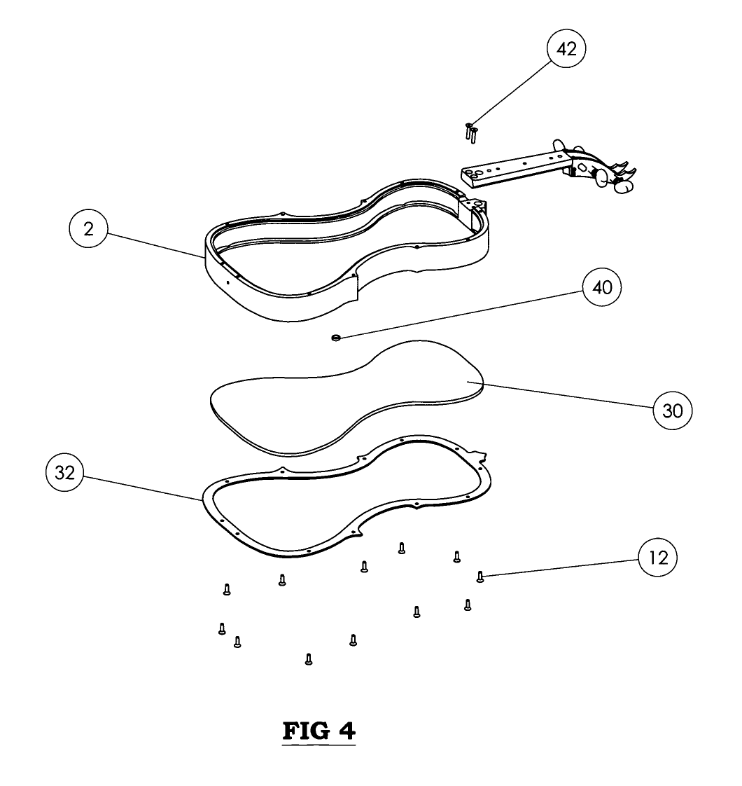

In FIG. 4 The neck sub-assembly from FIG. 3 is then affixed to an AL Side 2 using Screws 42. An AL Soundpost Guide 40 is affixed to a CF Back 30 with epoxy adhesive. The Back is then sandwiched between an AL Back Edge Trim 32 and the Side using Screws 12 to affix them. The Back Edge Trim is a cosmetic piece. In other embodiments the Back Edge Trim could be eliminated by expanding the Back and providing a means of fastening to the side, or by incorporating the Back and Side into one piece.

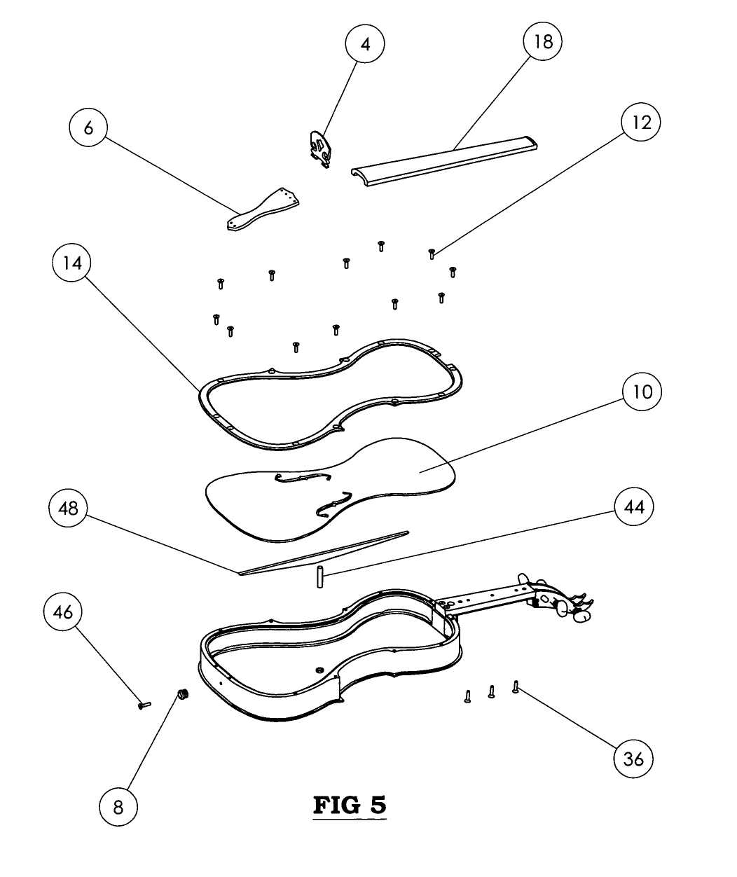

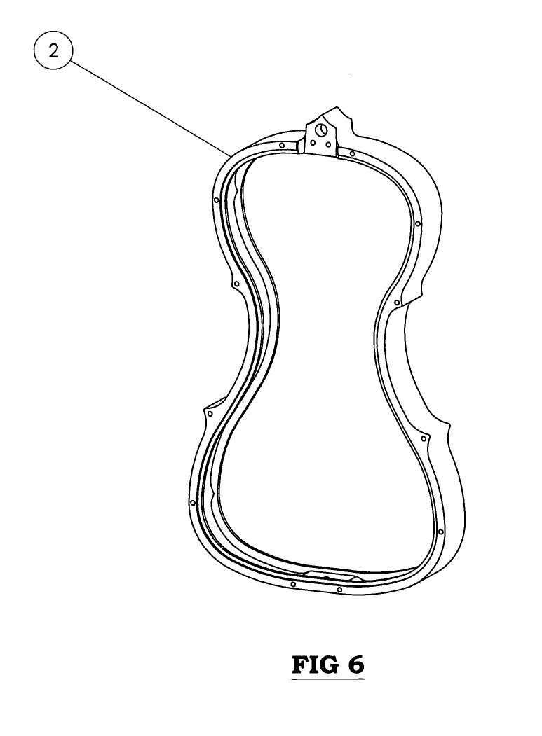

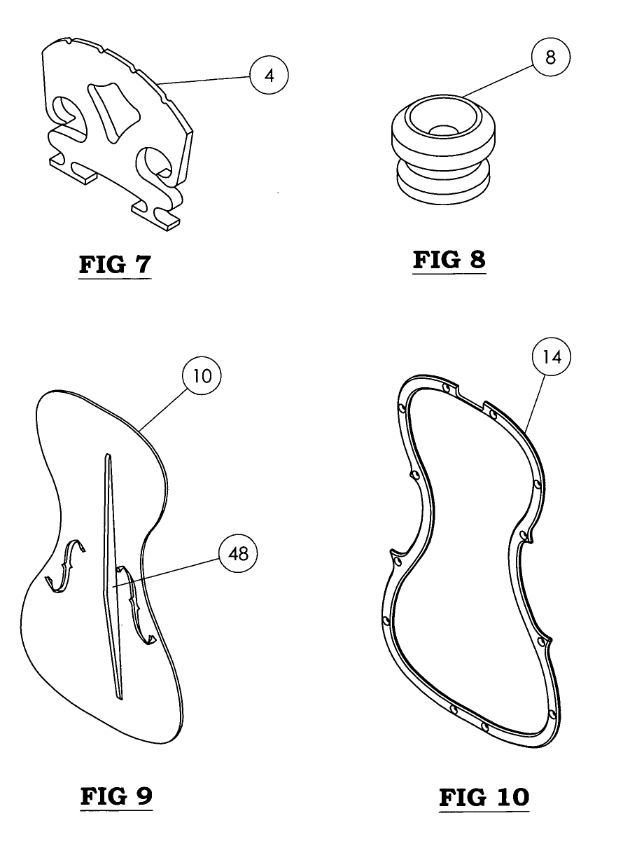

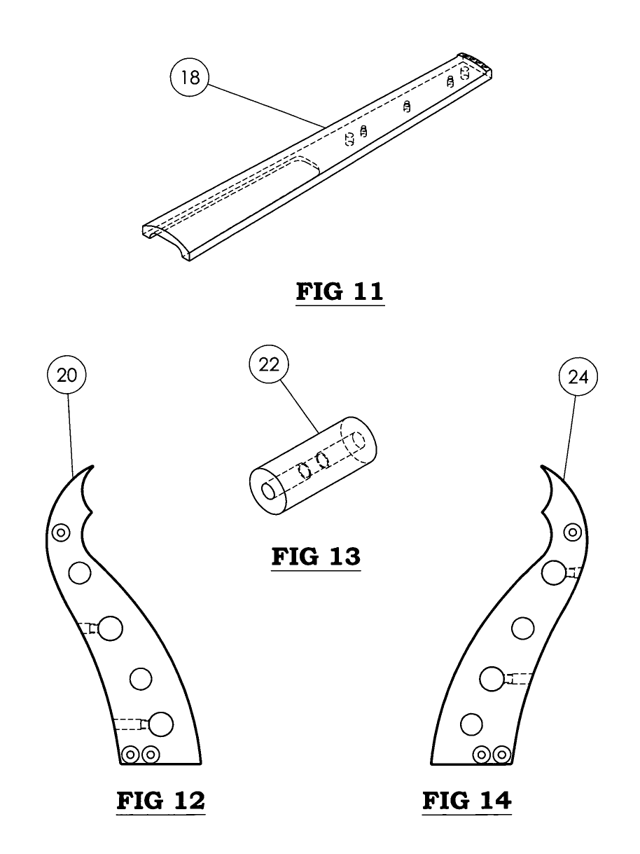

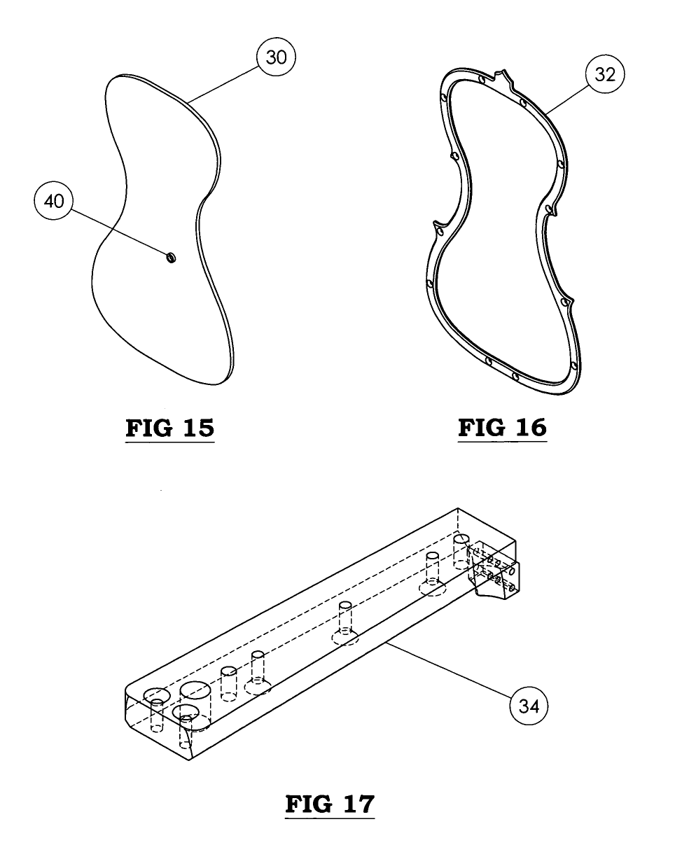

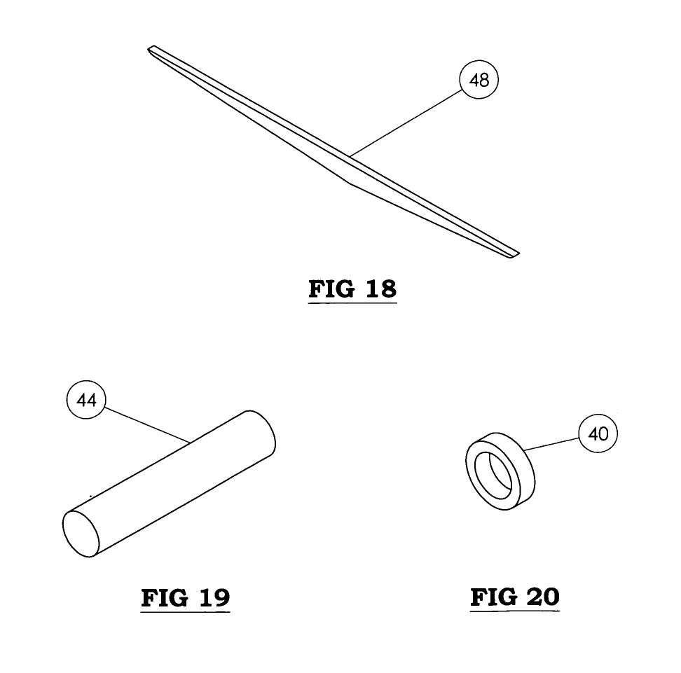

In FIG. 5 the assembly from FIG. 4 is carried over. An AL Button 8 is affixed to the Side using a Screw 46. A CF Soundpost 44 is then placed in the Soundpost Guide. An AL Fingerboard 18 is affixed to the Neck using Screws 36. A CF Bass Bar 48 is then affixed to a CF Top 10 with epoxy adhesive. The Top is sandwiched between an AL Top Edge Trim 14 and the Side using Screws 12 to affix them. Similar to the Back Edge Trim; the Top Edge Trim is a cosmetic piece and in other embodiments could be eliminated by expanding the Top and providing a means of fastening to the Side. A standard Tailpiece 6, such as those manufactured by Thomastik, is affixed to the Button. A standard set of strings, such as those manufactured by Thomastik, is drawn taught between the Tailpiece and the Pegs. The tension of these strings secures the Bridge.

Other fiber/matrix composites, such as aramid/epoxy, or light weight metals, such as magnesium, could be substituted. Where metal is utilized for a component in this embodiment, fiber/matrix composite could be substituted in other embodiments. Different manufacturing techniques, such as casting of AL parts, could also be utilized. Other embodiments may be utilized providing the final form as defined in the claims is satisfied.

What is claimed is:

1. A stringed musical instrument of the violin family comprised of a plurality of components made from a metal alloy, a plurality of components made from a composite fiber-in-matrix material, and joined by a means of fastening, whereby durability and serviceability are enhanced.

2. The instrument in claim 1 wherein said metal alloy is an aluminum alloy.

3. The instrument in claim 1 wherein said metal alloy is a magnesium alloy.

4. The instrument in claim 1 wherein said metal alloy is a titanium alloy.

5. The instrument in claim 1 wherein said composite fiber-in-matrix material is a carbon fiber composite.

6. The instrument in claim 1 wherein said composite composite fiber-in-matrix material is an aramid fiber composite.

7. The instrument in claim 1 wherein said composite fiber-in-matrix material is a combination of carbon fiber and aramid fiber composite.
